(19) United States
(12) Patent Application Publication
(10) Pub. No.: US 2013/0284582 A1
(43) Pub. Date: Oct. 31, 2013

(54) Systems and Methods for Low Temperature Recovery of Fractionated Water

(71) Applicant: Donald W. Booth, Charleston, WV (US)

(72) Inventor: Donald W. Booth, Charleston, WV (US)

(21) Appl. No.: 13/925,036

(22) Filed: Jun. 24, 2013

Related U.S. Application Data
(63) Continuation-in-part of application No. 12/878,155, filed on Sep. 9, 2010, now Pat. No. 8,470,139.
(60) Provisional application No. 61/285,669, filed on Dec. 11, 2009.

(51) Int. Cl. C02F 1/06

(52) U.S. Cl. CPC C02F 1/06
USPC 202/178

(57) ABSTRACT

In accordance with one embodiment, a recovery unit for treating fractionated water produced by a hydraulic fracturing process is provided. The recovery unit comprises a feed strainer in fluid communication with at least one feed pump that is in fluid communication with at least one flash tank. The unit may also include at least one pre-heater in fluid communication with a condensate pot and vacuum pump, the at least one pre-heater receiving steam and the condensate pot and vacuum pump condensing the steam for transfer to at least one condensate water storage tank and removing any non-condensable gas to transfer fluid to at least one condensate storage tank. The recovery unit may include one or more flash tanks in fluid communication with separate salt settling tanks and transfer pumps for removing salt (crystals) from the brine fluid at various stages of the treatment process.

### CROSS REFERENCE TO RELATED APPLICATIONS

This application is a continuation-in-part of U.S. application Ser. No. 12/878,155, which claims the benefit of U.S. Provisional Application No. 61/285,669, filed Dec. 11, 2009 which is incorporated herein by reference.

### BACKGROUND

Embodiments of the present invention generally relate to methods for the recovery of fractionated water, and specifically relate to methods to recover salt and condensed water from fractionated water under low temperature and pressure conditions.

Hydraulic fracturing is a process applied to drilled oil and gas well holes to improve the ability of fluids (such as oil and gas) to flow from the petroleum bearing formation to the drill hole. It involves injecting high pressure fracturing fluid into the rock formation with various additives, thereby causing the formation to fracture circumferentially away from the hole. During the fracturing process, the injected fracturing fluid is recovered, while the oil and gas flows from the rock formation into the drill hole and up to the well surface. The fracturing process is often necessary for economical well production.

The fractionation of water results from the hydraulic fracturing process, specifically, the chemical additions that are typically used as part of the fracturing process. In the fracturing process, sand is forced under pressure into the cracks that are pressure induced into the oil or gas underground formation. The sand is carried deep into the cracks of the formation by a viscous gel. The gel is “broken” to allow the release of sand at the sand's point of furthest ingress into the formation crack. Typically, the breaking process is initiated by an enzyme breaker. Upon breaking, the fractionated water is removed from the well, and may be treated with one or more treatment methods.

Many oil and natural gas operations generate significant quantities of fractionated water, in addition to their desired hydrocarbon products. Typically, fractionated water is contaminated with significant concentrations of chemicals that require treatment before the water may be reused or discharged to the environment. Fractionated water may contain natural contaminants that are mixed with the water as a result of the fracturing process, such as hydrocarbons and inorganic salts. It may also contain synthetic contaminants, such as spent fracturing fluids including polymers and inorganic cross linking agents, polymer breaking agents, friction reduction chemicals, and lubricants. These synthetic contaminants, which are utilized in the drilling process, remain in the fractionated water upon extraction to the surface

Some methods used to recover and process fractionated water utilize a series of evaporators, each one having a higher temperature than the preceding one. Such methods consume tremendous amounts of energy and require specialized boiler plant operators.

Accordingly, there remains a need for a recovery unit for fractionated water that is energy efficient, and cost effective.

### SUMMARY OF INVENTION

These and additional objects and advantages provided by the embodiments of the present invention will be more fully understood in view of the following detailed description, in conjunction with the drawings.

In accordance with one embodiment, a recovery unit for treating fractionated water from a hydraulic fracturing process, the recovery unit comprising a feed strainer in fluid communication with at least one feed pump, the feed strainer having electronic equipment for monitoring plugging of the feed strainer; the at least one feed pump in fluid communication with at least one flash tank, the at least one feed pump adapted to transfer raw brine fluid from external storage into the recovery unit; at least one pre-heater in fluid communication with a condensate pot and vacuum pump, the at least one pre-heater receiving steam and the condensate pot and vacuum pump condensing the steam for transfer to at least one condensate water storage tank and removing any non-condensable gas to transfer fluid to at least one condensate storage tank; and flow and density instrumentation to estimate reaction profiles within the recovery unit; wherein the strainer, the at least one feed pump, the at least one flash tank, and the at least one pre-heater and condensate pot and vacuum pump comprise a material resistant to corrosion, stress, and cracking from direct contact with chloride salts.

In accordance with another embodiment, a recovery unit for treating fractionated water from a hydraulic fracturing process, the recovery unit comprising a feed strainer in fluid communication with at least one feed pump; the at least one feed pump in fluid communication with at least one flash tank; at least one pre-heater in fluid communication with a pre-heater condensate pot and vacuum pump, the at least one pre-heater receiving steam and the pre-heater condensate pot and vacuum pump condensing the steam for transfer to at least one condensate water storage tank and removing any non-condensable gas to transfer fluid to at least one condensate storage tank; the at least one flash tank separating brine fluid and steam, the at least one flash tank in fluid communication with a salt settling tank, the salt settling tank having a bottom outlet point for collecting crystals from the brine fluid; the salt settling tank in fluid communication with at least one circulation pump for transferring the crystals from the brine fluid to the at least one circulation pump; the at least one circulation pump to control flow rate for heat exchange by at least one heat exchanger; the at least one heat exchanger in fluid communication with a heat exchanger condensate pot and vacuum pump, the at least one heat exchanger receiving steam and the heat exchanger condensate pot and vacuum pump condensing steam for transfer and removing any non-condensable gas to transfer fluid to at least one condensate storage tank; flow and density instrumentation to estimate reaction profiles within the recovery unit; and a level control in communication with a control valve, the level control providing a signal to the control valve to maintain a programmed level in the at least one flash tank.

In accordance with another embodiment, a recovery unit for treating fractionated water from a hydraulic fracturing process, the recovery unit comprising a feed strainer in fluid communication with at least one feed pump; the at least one feed pump in fluid communication with at least one flash tank; at least one pre-heater in fluid communication with a pre-heater condensate pot and vacuum pump, the at least one pre-heater receiving steam and the pre-heater condensate pot and vacuum pump condensing the steam for transfer to at least one condensate water storage tank and removing any non-condensable gas to transfer fluid to at least one condensate storage tank; a first flash tank, a second flash tank, and third flash tank, the first flash tank in fluid communication with the second flash tank, the second flash tank in fluid communication with the third flash tank, each one of the flash tanks separating brine fluid and steam, and each one of the flash tanks in fluid communication with an associated salt settling tank, each one of the salt settling tanks having a bottom outlet point for collecting crystals from the brine fluid; each one of the salt settling tanks in fluid communication with at least one circulation pump for transferring the crystals from the brine fluid to the at least one circulation pump; the at least one circulation pump to control flow rate for heat exchange by at least one heat exchanger for each one of the flash tanks and salt settling tanks; the at least one heat exchanger in fluid communication with a heat exchanger condensate pot and vacuum pump, the at least one heat exchanger receiving steam and the heat exchanger condensate pot and vacuum pump condensing steam for transfer and removing any non-condensable gas to transfer fluid to at least one condensate storage tank; a hot oil heater in fluid communication with the at least one heat exchanger for increasing the brine fluid temperature; flow and density instrumentation to estimate reaction profiles within the recovery unit; and a level control in communication with a control valve, the level control providing a signal to the control valve to maintain a programmed level in the at least one flash tank.

In another embodiment, it is envisioned that the recovery unit described above may further comprise at least one salt transfer pump transferring recovered crystals a flash tank to a different flash tank. In such an embodiment, the at least one salt transfer pump flow is determined by brine density calculated by the flow and density instrumentation. It is further envisioned that the recovery unit may further comprise a crystal dryer to reduce moisture content in the recovered crystals from the brine fluid, wherein the crystal dryer may comprise a centrifuge. It is also envisioned that the recovery unit may comprise a crystal washer providing water for removing additional impurities from the recovered crystals.

In another embodiment, the recovery unit may further comprise a steam condensing heat exchanger for removing latent heat from steam using low temperature fluid circulated therethrough, the steam condensing heat exchanger in fluid communication with a condensate pot and vacuum pump for condensing steam for transfer and removing any non-condensable gas to transfer fluid, wherein the low temperature fluid is water cooled or may be air cooled.

### BRIEF DESCRIPTION OF THE DRAWINGS

The following detailed description of the embodiments of the present invention can be best understood when read in conjunction with the following drawings, where like structure is indicated with like reference numerals, and in which:

FIG. 1 shows a flow diagram illustrating a system for the treatment of fractionated water according to one or more embodiments of the present disclosure; and

FIGS. 2, 3A and 3B show a flow diagram illustrating a system for the treatment of fractionated water according to another embodiment of the present disclosure

The embodiments set forth in the drawings are illustrative in nature and not intended to be limiting of the invention defined by the claims. Moreover, individual features of the drawings and invention will be more fully apparent and understood in view of the detailed description.

Skilled artisans appreciate that elements in the figures are illustrated for simplicity and clarity and have not necessarily been drawn to scale. For example, the dimensions of some of the elements in the figures may be exaggerated relative to other elements, as well as conventional parts removed, to help to improve understanding of the various embodiments of the present invention.

### DETAILED DESCRIPTION

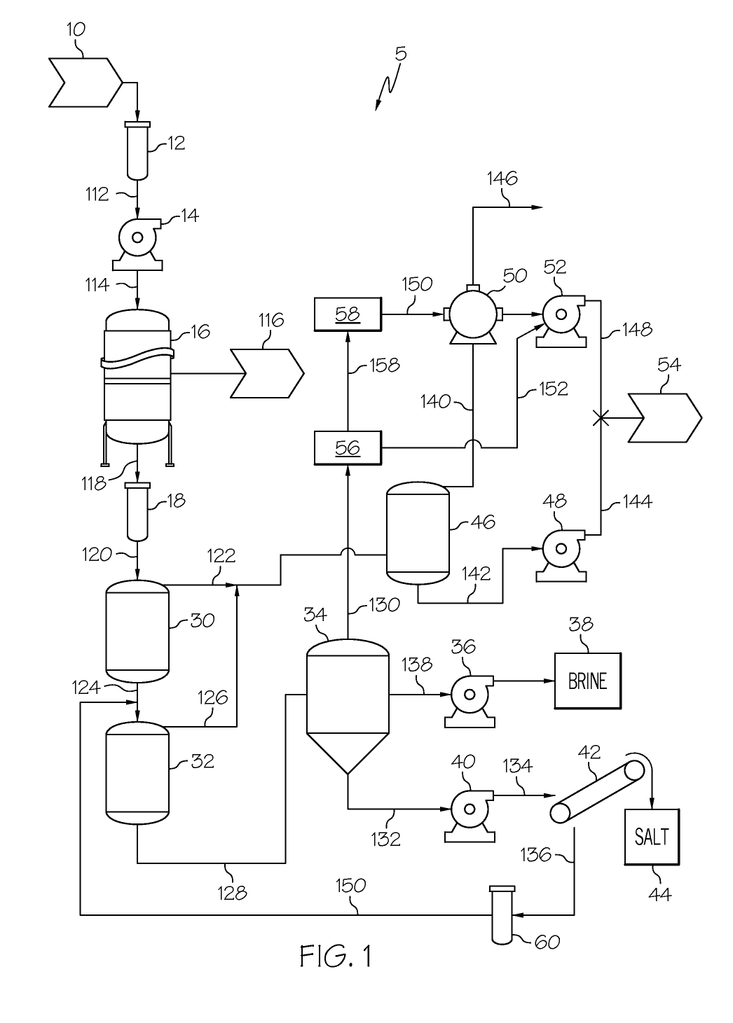

In one embodiment, referring to FIG. 1, a flow diagram of a system for treating fractionated water produced by a hydraulic fracturing process is provided. The method includes decanting a fractionated water stream 10. The decanter 16 is maintained at a temperature ranging from about 90° F. to about 120° F. The method also includes flashing the decanted water 118 in a first flash tank 30 and a second flash tank 32 which are in fluid communication with one another in order to provide a residual concentrate stream 128. The first flash tank 30 may be operated at a temperature ranging from about 180° F. to about 200° F. The second flash tank 32 may be operated at a temperature ranging from about 140° F. to about 160° F. Both the first flash tank 30 and the second flash tank 32 are maintained at a vacuum pressure.

The method also includes evaporating the residual concentrate stream 128 in at least one evaporator kettle 34 to produce concentrated brine 132. The evaporator kettle 34 is fluidly connected to the second flash tank 32. The evaporator kettle 34 is operated at a temperature ranging from about 95° F. to about 115° F., and is maintained at a vacuum pressure. The method also includes dewatering the concentrated brine 132 to produce recovered salt 44 having less than about 20 wt. % water.

The fractionated water stream 10 results from hydraulic fracturing of oil-gas wells. The fractionated water stream 10 may comprise various concentrations of dissolved solutes. In one or more embodiments, the fractionated water stream 10 comprises a solute concentration ranging from about 100,000 to about 300,000 ppm, or from about 150,000 to about 200,000 ppm. The fractionated water stream 10 may contain a wide variety of components, including but not limited to, sodium chloride, calcium salts, surfactants, hydrocarbons, rock, shale, other salts and other contaminants.

In one embodiment, the recovery unit 5 comprises at least one strainer 12. The strainer 12 removes solids, such as iron, rock, sand, and oil from the fractionated water stream 10 to produce strained water 112. These solid materials may interrupt and damage the proper functioning of the recovery unit 5, and should be removed before entering the decanter 16. In one possible configuration, the strainer 12 is configured to remove particles larger than 1 micron in size. Alternatively, it is also contemplated that the strainer 12 may be used to remove particles larger than 1, 3, 5, or 10 microns in size, depending on the composition of the fractionated water stream 10. After straining, the strained water 112 may be pumped by at least one feed pump 14 to a decanter 16 for further processing. The strainer 12 may include electronic equipment for monitoring the potential plugging of the strainer 12.

The feed pump 14 may typically have a capacity ranging from about 20 to about 200 gallons per minute (gpm). Alternatively, it is also contemplated that the feed pump 14 may have other capacities to suit the demands of the method and system disclosed herein. Furthermore, although only one feed pump 14 is shown, any number of pumps may be used, depending on the amount of fractionated water to be processed.

Because the feed water 114 may contain surfactants and hydrocarbons that would ultimately contaminate the recovery unit 5, the surfactants and hydrocarbons must be removed from the feed water 114 before additional processing and evaporation can be conducted. These contaminants may include, but are not limited to, guar, weak acids, polymers, and various hydrocarbons. Thus, the decanter 16 is configured to isolate these contaminants, and output a recovered-oil surfactant stream 116 out of the recovery unit 5.

The decanter 16 heats the feed water 114 to a temperature where the surfactants, hydrocarbons, and other contaminants are separated from the remainder of the fractionated water. The recovered oil-surfactants 116 may be aggregated and collected in at least one holding tank for later processing or recycling operations. The decanted water 118, now substantially free from hydrocarbon and surfactant contaminants, exits the decanter 16, and may be pumped to at least one filter 18.

The temperature necessary to remove the recovered oil-surfactants 116 from the rest of the water may vary based on the composition of the feed water 114. The decanter 16 is usually operated at a temperature ranging from about 90° F. to about 120° F. The decanter 16 may also be operated at a temperature ranging from about 100° F. to about 110° F., or from about 80° F. to about 130° F. However, it is also contemplated that the decanter 16 may be operated at other temperatures, dependent on the composition of the feed water 114.

After removal of the hydrocarbons and surfactants by the decanter 16, the total dissolved solute levels of the decanted water 118 may range from about 200,000 ppm to about 250,000 ppm, or from about 225,000 to about 235,000 ppm. However, other solute concentrations are also contemplated.

The recovery unit 5 may comprise at least one filter 18. The filter 18 removes any remaining solids and hydrocarbon droplets still remaining after processing by the strainer 12 and the decanter 16. The filtrate 120 produced by the at least one filter 18 may be pumped to the first flash tank 30 to begin the flashing step.

The filter 18 may be a bag type filter, a screen filter, and other filter types as will be appreciated by one of ordinary skill The recovery unit 5 may include any number of filters 18 necessary to conduct the filtration operation depending on the flow levels of the fractionated water stream 10. In one configuration, the recovery unit 5 comprises two filters. Alternatively, the recovery unit may comprise anywhere from 1 filter to 10 filters. The filter 18 may have an effective filtration dimension operable to filter out any remaining solids and hydrocarbon droplets. Alternatively, the filter 18 may comprise a series of filters, cascading in filter size, where the first filter has a larger dimension, cascading down to a second filter having a smaller filter dimension, and a third filter having an even smaller filter dimension.

The recovery unit 5 may comprise at least one flash tank (30, 32). The flash tank (30, 32) may function to flash off vapor from the filtrate 120, thereby concentrating the solution through vaporization of a portion of the remaining water present in the filtrate 120. The vapor produced by the flash tank (30, 32) typically comprises pure water, as well as some non-condensable gases. In one configuration, the recovery unit 5 comprises a first flash tank 30 and a second flash tank 32. Alternatively, the recovery unit 5 may include one, two, three, four, or five flash tanks provided in series or in parallel.

In one embodiment, the filtrate 120 is pumped into the first flash tank 30, and a first vapor stream 122 is flashed off, while a first concentrate stream 124 is pumped out to a second flash tank 32 for further processing. The first vapor stream 122 may be transferred to a condensate pot 46 for further processing as will be described in further detail below.

The first flash tank 30 may be operated at a vacuum pressure. The first flash tank 30 may be operated at a vacuum pressure ranging from about 3 psi to about 7 psi, or from about 4 psi to about 6 psi, or about 5 psi. The first flash tank 30 may be operated at a temperature ranging from about 175° F. to about 205° F., or from about 180° F. to about 200° F., or from about 185° F. to about 195° F. The lower temperatures are feasible for flashing due to the lower pressures provided in the tank. However, it is also contemplated that the first flash tank 30 may be operated at other temperatures suitable to flash additional water from the solution.

The first flash tank 30 may be controlled using a sensor configured to monitor the level of the solution in the tank, and a controller programmed to adjust the temperature to achieve the desired concentration level. The first flash tank 30 may include a hinge valve that operates to allow steam to exit the vessel when a given temperature/pressure is reached. The first flash tank 30 may also include a level control suitable to maintain a predetermined level of solution.

As shown in FIG. 1, the second flash tank 32 may receive the first concentrate stream from the first flash tank 30. The second flash tank 32 may have a similar design as the first flash tank 30, and function to further heat the first concentrate stream 124 and flash additional water from the solution.

Similar to the first flash tank 30, the second flash tank 32 may be operated at a range of temperatures suitable to produce the desired composition of the residual concentrate stream 128. However, the second flash tank 32 may be maintained at an even lower pressure than the first flash tank 30, thus, it may be operated at a lower temperature than the first flash tank 30. The second flash tank 32 may be operated at a vacuum pressure ranging from about 9 psi to about 14 psi, or from about 10 psi to about 12 psi, or about 11 psi. The second flash tank 32 may be operated a temperature ranging from about 130° F. to about 170° F., or from about 140° F. to about 160° F., or from about 145° F. to about 155° F. However, it is also contemplated that the second flash tank 32 may be operated at other temperatures.

The residual concentrate stream 128 that is transferred to the evaporator kettle 34 for additional evaporation. The evaporator kettle 34 functions to evaporate additional water from the solution. The evaporator kettle 34 may be operated in a variety of modes described below, where each mode is configured to produce different compositions of a brine/salt mixture depending on the needs of the user.

The evaporator kettle 34 is operated at a temperature sufficient to evaporate additional water. The evaporator kettle 34 is maintained at a vacuum, thus allowing the evaporation step to be conducted at a temperature much lower than typically necessary under non-vacuum conditions. The evaporator kettle 34 may be operated at a vacuum pressure ranging from about 10 psi to about 17 psi, or from about 12 psi to about 15 psi, or about 13 psi to about 14 psi. The evaporator kettle 34 is operated at a temperature ranging from about 85° F. to about 125° F., or from about 95° F. to about 115° F., or from about 100° F. to about 110° F.

In one embodiment, the recovery unit 5 includes a condensate pot 46. The condensate pot 46 collects and aggregates the vapor streams produced by the various evaporation and flash tanks. For example, the condensate pot 46 may collect the first vapor stream 122, and the second vapor stream 126 from the first flash tank 30 and the second flash tank 32 respectively. The condensate pot 46 allows the condensate from the vapor streams mentioned above to collect in a common vessel. The condensate pot 46 outputs both a non-condensable gas line 140, and a condensate liquid 142. The condensate pot 46 may also be in fluid communication with a vacuum pump 50 via the non-condensable gas line 140. The recovery unit 5 may also include a condensate pot pump 48, to pump the condensate liquid 142 to the condensate outlet 54 via a pumped condensate pot line 144. A condensate pot pump 48 pumps the condensate liquid 142 from the condensate pot 46 to the condensate outlet 54.

The primary source of vacuum is generated throughout the recovery unit by condensing the kettle vapor stream 130 in a condenser 56. The condenser 56 produces a liquid water stream, the condenser output 152. By condensing the steam, a vacuum is created within the entire recovery unit 5, thus lowering the operating pressure of the first flash tank 30, the second flash tank 32, and the evaporator kettle 34. Because a vacuum is present in each of the aforementioned vessels, they may achieve evaporation and flashing at relatively low temperatures, thus saving enormous amounts of energy. The condenser 56 may be fluidly connected gas separation chamber 58 via a condenser gas line 158, in order to remove the non-condensable gases from the condenser 56.

In one configuration, the condenser 56 comprise a fin tube fan cooled type condenser powered by an electrical 60 horsepower fan. Alternatively, the condenser 56 may be chilled using cold water, streaming air, or other cooling methodology, as will be appreciated by one of ordinary skill As mentioned above, the condenser 56 may also be fluidly connected to a gas separation chamber 58 for further separation of the liquid phase from the gaseous phase. The non-condensable gases that accumulate in the condenser 56 are transferred to the gas separation chamber 58.

The gas separation chamber 58 is connected to a vacuum pump 50 and a condenser pump 52. The condenser pump 52 may be configured to pump the condensate stream 152 along with the liquid contents of the gas separation chamber as a pumped condenser line 148 and combine it with the condensate outlet 54. The non-condensable gases present in the chamber 58 are removed with a vacuum pump 50 via a gas escape line 150, and emitted from the recovery unit 5 as a non-condensable gas stream 146. The liquid present in the gas separation chamber 58 may removed by the condenser pump 52, and is removed from the system as condensate 54. The vacuum pump 50 allows the recovery unit 5 to maintain the vacuum pressures described above and keep the non-condensable gases from building up in the recovery unit 5.

The vacuum pump 50 may provide various amounts of vacuum pressure to the gas separation chamber 58. In one configuration, the vacuum pump 50 may provide a vacuum pressure within the gas separation chamber 58 ranging from about 0.5 psi to about 1 psi, or from about 0.5 psi to about 3 psi. The vacuum pump 50 operates to remove the non-condensable materials from the gas separation chamber 58. Because the non-condensable materials may not condensed under conditions that will condense the other vapor streams (mainly steam), they must be continually removed from the system to ensure smooth, uninterrupted system operation. The vacuum pump 50 outputs a vacuum outlet 146. The vacuum outlet 146 comprises non-condensable gases, such as carbon dioxide. These gases are removed from the various vessels and released into the atmosphere. The condensable gases may comprise from 0 wt. % to 2 wt. % of the fractionated water stream 10, or from about 0.5 wt. % to about 1 wt. %.

In a brine production mode, the evaporator kettle 34 is operated to produce a brine stream 138, which is pumped out by the brine pump 36 as a brine outlet 38. The brine pump 36 may draw out the brine stream 138 before the saturation point of the solution is met, and thus, minimal amounts of solids are precipitated out of the solution. The brine outlet 38 may have a total dissolved solids level ranging from about 230,000 to about 300,000 ppm, or from about 250,000 to about 280,000 ppm. However, it is also contemplated that the brine outlet 38 may comprise other concentrations of total dissolved solutes. The brine outlet 38 may be pumped to a holding tank, and may be subsequently reused in an oil-gas well hydraulic fracturing process. Alternatively, the brine outlet 38 may be used for other commercial and industrial uses.

In a salt concentrate mode, the evaporator kettle 34 may be operated until salt precipitates to the bottom of the evaporator kettle 34 and is removed by the salt concentrate pump 40 as a concentrated brine 132 which contains precipitated salt and small amounts of brine. The concentrated brine 132 may comprise a composition ranging from about 60 wt. % to about 80 wt. % water. Alternatively, the concentrated brine 132 may comprise a composition ranging from about 65 wt. % to about 75 wt. % water. However, it is also contemplated that the concentrated brine 132 may comprise other mixtures for use in the process disclosed herein.

A dewatering conveyor 42 may receive the concentrated brine 132 from the salt concentrate pump 40, and dewater the concentrated brine 132 to produce recovered salt 44 and a residual water stream 136. The dewatering conveyor 42 may comprise a device operable to compress the pumped salt stream 134 and drain any water from the solid composition to produce a recovered salt 44. In addition, the dewatering conveyor 42 allows the residual heat of the pumped salt stream 134 to provide sufficient heat to evaporate remaining moisture present on the solid salt product. In one embodiment, the dewatering conveyor 42 may be similar to the unit produced by Meyer Industries. However, other types and configurations of dewatering conveyors 42 are also contemplated for use within the methods and apparatuses disclosed herein. The recovered salt 44 may be transferred to large storage containers for shipping, or immediate use. The residual water stream 136 that is released by the dewatering conveyor 42 is pumped to at least one circulation filter 60 for additional processing and recycling.

The recovered salt 44 may have varying compositions, depending on the composition of the fractionated water stream 10. The recovered salt 44 may include calcium salts, sodium chloride, and other salts and contaminants. In one configuration, the recovered salt 44 may comprise from about 10 wt. % to about 30 wt. % calcium salts, or from about 50 wt. % to about 90 wt. % sodium chloride, or from about 0.01 wt. % to about 3 wt. % other salts and contaminants. In another configuration, the recovered salt 44 may comprise a solid salt product having less than 2% other salts and contaminants, or from about 0.01 wt. % to about 1 wt. % other salts and contaminants. The recovered salt 44 may have less than about 20 wt. % water, or less than about 15 wt. % water, or less than about 10 wt. % water, or less than about 5 wt. % water.

The condensate outlet 54 may comprise a relatively pure water stream that is suitable for drinking. The condensate outlet 54 may aggregate the condensed water streams produced by the recovery unit 5. The condensate outlet 54 may comprise a total dissolved solutes level ranging from less than 2000 ppm, less than about 1500 ppm, less than about 1000 ppm, or less than about 500 ppm, or from about 50 ppm to about 225 ppm. The condensate outlet 54 may feed into a storage tank or may be recycled to various stages of the process. In one configuration, the condensate outlet 54 may be recycled for further oil-gas well fractionation.

Referring to another embodiment as shown in FIG. 1, at least one circulation filter 60 receives the residual brine stream 136 from the dewatering conveyor 42. The circulation filter 60 removes the particulate matter from the residual brine stream 136, and re-circulates the solution to the second flash tank 32 for reprocessing. In one configuration, the circulation filter 60 is a bag filter. However, other types of filtering devices may also be used in conjunction with the process. It is contemplated that the circulation filter 60 may have an effective filtration dimension operable to filter out any remaining solids, and hydrocarbon droplets. In another configuration, it is contemplated that the circulation filter 60 comprises an alternative type of filter device suitable for use in combination with the device and process described herein to remove any remaining solids and hydrocarbon droplets.

Entrainment separators may be used in conjunction with the first flash tank 30, the second flash tank 32, and the evaporator kettle 34 as will be appreciated by one having ordinary skill The entrainment separators may comprise devices suitable to prevent a liquid component from escaping a vessel aside the vapor component. In one configuration, the entrainment separators may be a centrifugal force entrainment separator. The entrainment separators allow vapor to pass through, while channeling the liquid component back into the main vessel. Therefore, when water is vaporized in the aforementioned vessels, it passes through the entrainment separators. Any liquid water is blocked from passage, and is transferred back to the vessel for additional evaporation.

Most fractionated water recovery systems utilize vapor recompression systems to provide heat to the recovery unit. In contrast, the present disclosure utilizes a hot oil system to heat the decanter 16, the first flash tank 30, the second flash tank 32, and the evaporator kettle 34 along with the various heat exchangers and pre-heaters found in the process. In one configuration, the recovery unit is heated without using vapor recompression. Because no vapor recompression is used in conjunction with the recovery unit 5, no boiler plant is necessary. Therefore, the requisite certifications, inspections, and safety measures that are associated with the boiler plant can be avoided. Accordingly, it is contemplated that all of the flashing and evaporating operations in the recovery unit 5 are operated at a temperature lower than 212° F., or lower than 200° F., or lower than 195° F. In another configuration, the recovery unit 5 includes no steam at a temperature higher than about 212° F.

A hot oil system may be used to supply heat to the various unit operations of the recovery unit. The hot oil system may comprise a network of pipelines configured to transport hot, and cooled oil around to the unit operations of the recovery unit. The hot oil system may include heat outlets provided at the decanter 16, the first flash tank 30, the second flash tank 32, the evaporator kettle 34, and through a plurality of heat exchangers located through the recovery unit 5 as will be described below.

As mentioned above, the fractionated water stream 10 often contains various chlorides and salts. As vaporization takes place in the flash tanks 30, 32 and the evaporator kettle 34, the chlorides become more and more concentrated. This high concentration of chlorides results in an extremely corrosive environment. The corrosive environment may damage the various vessels, piping, and unit operations. Accordingly, the recovery unit 5 described herein features only minimal metallic parts. Particularly, in one configuration, the recovery unit 5 only has one metallic feature; the various heat exchangers and pre-heaters may comprise titanium components. Therefore, the entire unit comprises corrosion resistant contact surfaces. By contact surfaces, it is understood to mean the surfaces of the recovery unit 5, which contact the liquid or gaseous components of the fractionated water stream 10.

The first flash tank 30, the second flash tank 32, and the evaporator kettle 34 may each comprise non-metallic contact surfaces. In one configuration, the non-metallic contact surfaces comprise a polymer lining. It is contemplated that the polymer lining may degrade at temperatures higher than about 212° F. The polymer lining may comprise a Belzona lining. Because the first flash tank 30, the second flash tank 32, and the evaporator kettle 34 are each maintained at a temperature less than 200° F., the Belzona lining will not be damaged by excessive heat. The Belzona lining is corrosion resistant, and protects the related vessel. Other non-metallic, corrosion-resistant contact surfaces are also contemplated.

The recovery unit 5 may comprise a piping system comprising corrosion resistant contact surfaces. In one embodiment, the corrosion resistant contact surfaces comprise non-metallic contact surfaces. In one configuration, the non-metallic contact surfaces comprise Teflon coated contact surfaces. However, other non-metallic contact surfaces are also contemplated.

The hot oil system may be operated at a range of different fluid capacities, ranging from about 100 to about 1000 gallons per minute. However, it is also contemplated that the hot oil system may have other capacities necessary to fulfill the heating requirements of the recovery unit. In one or more embodiments, the hot oil system may be operated at a temperature ranging from about 200° F. to about 400° F., or from about 250° F. to about 350° F. However, it is also contemplated that the hot oil system can be operated at other temperatures.

In one embodiment, the hot oil system may be similar to the commercial systems manufactured by Gaumer. Alternatively, the unit operations of the process may be heated with gasoline, in-field petroleum, or propane. Furthermore, it is also contemplated that the hot oil system may be interchangeable with other conventional heating systems that will be appreciated by one of ordinary skill.

The recovery unit described herein may developed with an extensive energy optimization system. In one embodiment, the residual heat present in the different output streams of the decanter 16, first flash tank 30, second flash tank 32, and evaporator kettle 34 may be arranged in conjunction with a plurality of heat exchangers to ensure that no salvageable heat energy is squandered. For example, in one configuration, the steam from the first flash tank 30 may be used to preheat the first concentrate stream 124 before entry into the second flash tank 32. The steam/vapor outputs of the various vessels may be in heat communication with the input streams to downstream or upstream vessels, to ensure that any residual heat may be utilized by the process.

The recovery unit may make extensive use of pre-heaters to maximize the efficiency of the evaporation vessels, such as the decanter 16, first flash tank 30, the second flash tank 32, and the evaporator kettle 34. The pre-heaters are arranged to heat the feed streams that enter the aforementioned vessels, including the feed water 114, the filtrate 120, the first concentrate stream 124 and the residual concentrate stream 128. The pre-heaters may be heated with a circulating hot oil stream provided by the hot oil system described above, or may be heated with residual heat provided through heat exchange with condensate streams or steam which is produced by the various evaporation units described herein.

A programmable logic controller system (PLC) may be used to control, monitor, and record the operation of the recovery unit. The PLC controls the recovery unit through monitoring of the temperature, pressure, flow rates, conductivity, densities and other characteristics of the unit operations inlets and outlets, as well be appreciated by one of ordinary skill

In yet another embodiment, a portable recovery unit is provided. The portable recovery unit may comprise a moveable vehicle comprising a support surface. The apparatus discussed throughout the above disclosure may be configured to be mounted on the support surface. The portable recovery unit is sized to fit on a road trailer and comply with regulatory weight limits. Alternatively, the portable recovery unit can be disposed on any portable surface, such as a moveable platform, truck, or trailer. Also, the portable recovery unit weighs less than the maximum weight limits tolerated by public roads, and may be transported on a road trailer or vehicle. For example, the portable recovery unit described herein may weigh between 40000 lbs and 93000 lbs.

Various sizes are also contemplated for the portable recovery unit. For example, the portable recovery unit may be sized to fit easily on mountain side mining sites. Moreover, the portable recovery unit may be sized to treat between about 100 barrels per day and about 5000 barrels per day or from about 200 to about 3000 barrels per day. In addition, it is also contemplated that the various capacities of the unit operations disclosed herein may be adjusted to achieve a desired production capacity.

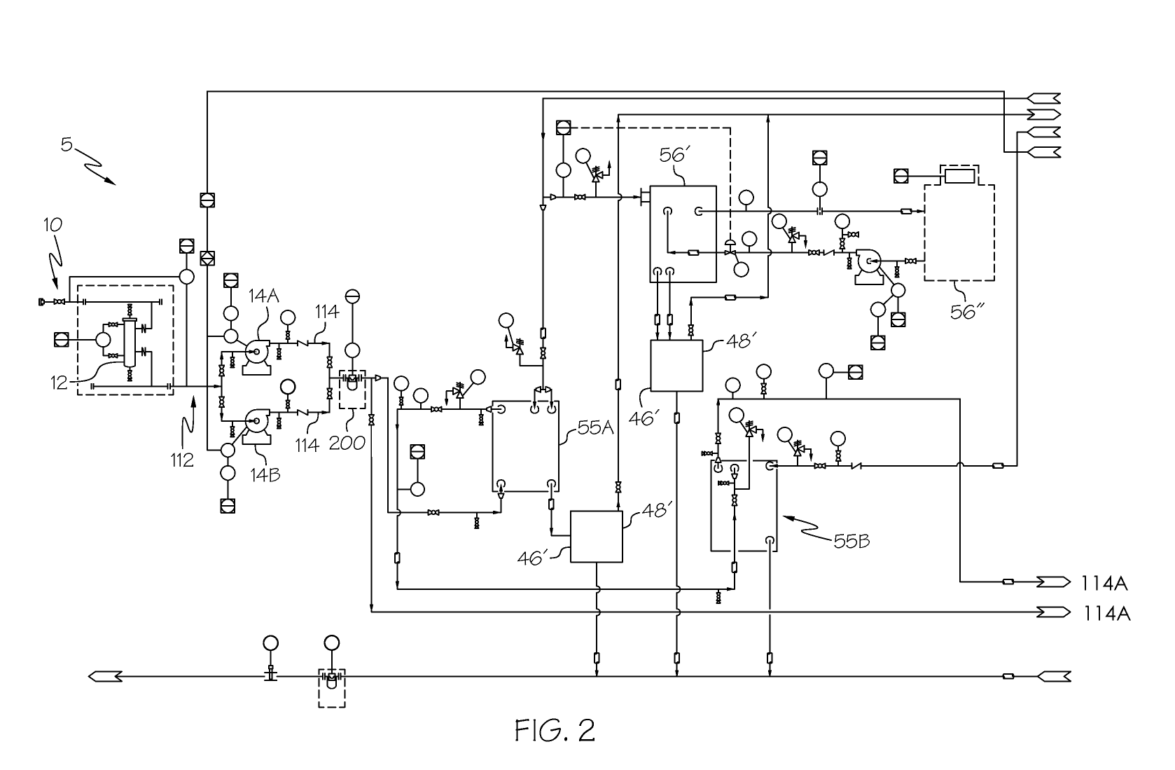

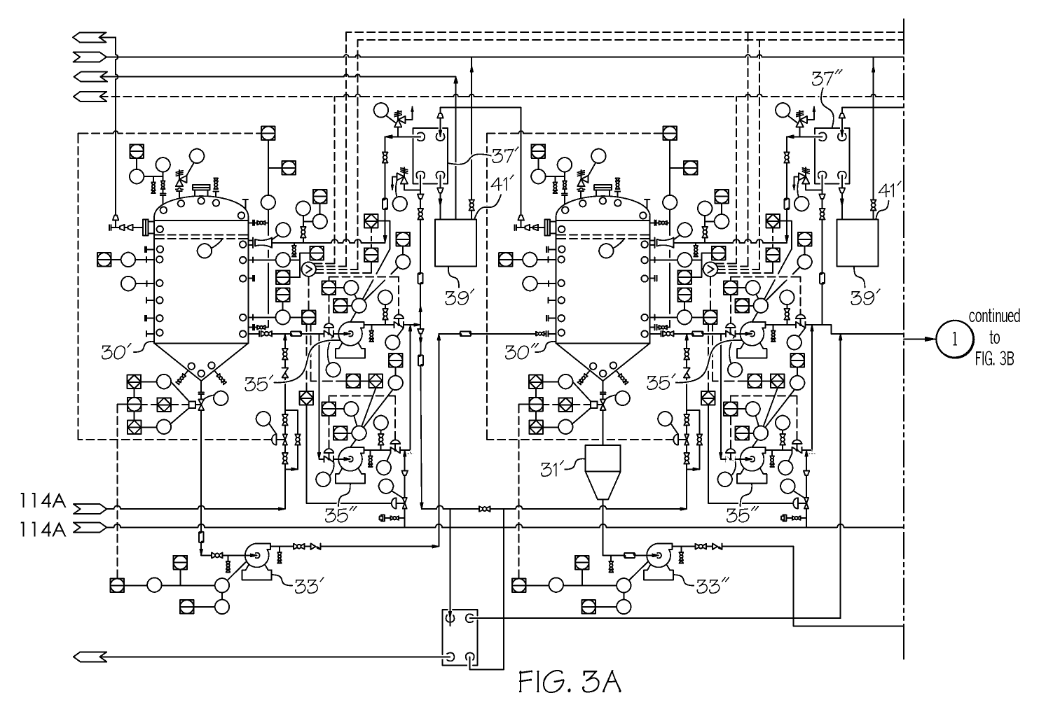

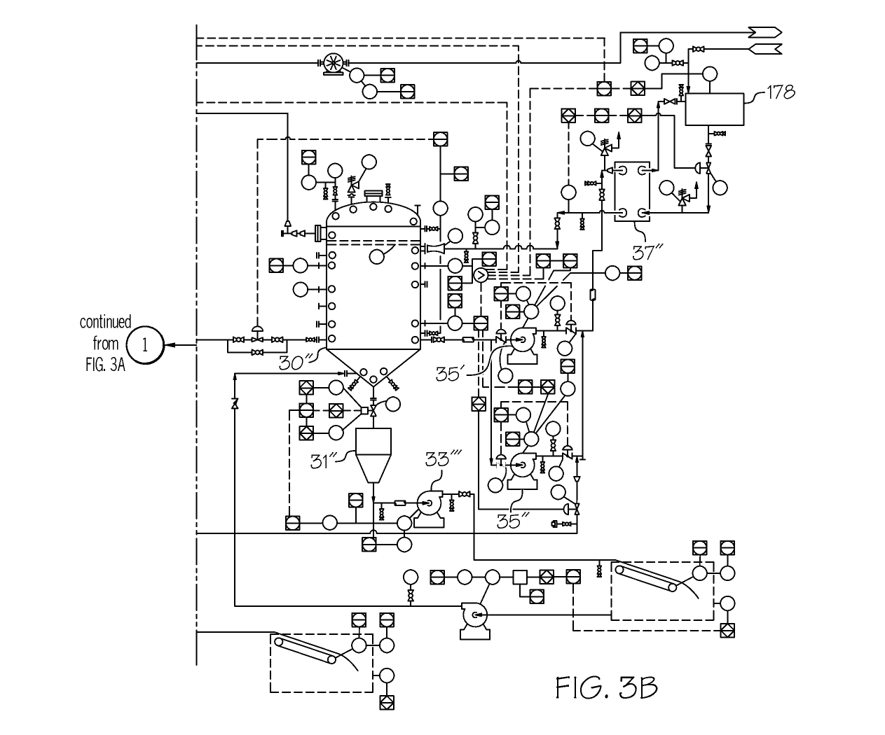

In another embodiment, using similar labels and reference characters where appropriate, FIGS. 2, 3A and 3B illustrate a variation of the embodiment illustrated and described by FIG. 1. In this embodiment it is contemplated that the feed water is pre-treated. The pre-treatment process is intended to, among other things, prepare water for final processing and polishing before entering the recovery unit 5, including the removal of any surfactants, hydrocarbons, heavy metals, sand, silica, dirt, sticks, and rock shale, from a fractionated water stream prior to its insertion as pre-treated, fractionated water stream 10 into this embodiment of the present invention.

The pre-treated, fractionated water stream 10 is delivered to the recovery unit 5, comprising a strainer 12 and feed pumps 14A and 14B. In accordance with the strainer 12 previously described, the strainer 12 in this embodiment receives a pre-treated fractionated water stream 10 and removes any remaining solids, such as rock and sand from the water stream 10 to produce strained water 112. These solid materials may interrupt and damage the proper functioning of the recovery unit 5, and should be removed. In one possible configuration, the strainer 12 is configured to remove particles larger than 1 micron in size, up to about ¼″ in size, depending on the composition of the fractionated water stream 10. The strainer 12 may include electronic equipment for monitoring the potential plugging of the strainer 12. The strained water 112 may be pumped by one or both feed pumps 14A and 14B as feed water 114. The feed pumps 14A and 14B may typically have a capacity ranging from about 20 to about 200 gallons per minute (gpm). Alternatively, it is also contemplated that the feed pumps 14A and 14B may have other capacities to suit the demands of the method and system disclosed herein. Furthermore, although two feed pumps 14A and 14B are shown, additional pumps may be used, depending on the amount of fractionated water to be processed.

The feed water 114 may be pumped to one or more pre-heaters 55A or 55B for increasing the temperature of the raw brine fluid from about 30° to 130° F., by condensing steam. Between the pumps 14A and 14B and the pre-heaters 55A and 55B, a monitor 200 may be incorporated to measure the flow rate and temperature of the feed water 114; further, readings from this monitor 200 may control the performance parameters of the pumps 14A and 14B, and the pre-heaters 55A and 55B. Associated with each pre-heater 55A or 55B is a condensate pot 46′ and vacuum pump 48′. The pot 46′ collects steam condensate from the pre-heater 55A or 55B. The condensate and gases are then transferred by means of pumps 48′ through the vapor condenser 56′ and associated fin fan system 56″ as hereafter described, and then on to one or more condensate storage tanks. Remaining feed water (including brine) 114 may be pumped or transferred to one or more of the flash tanks 30′, 30″, and/or 30′″ (as described in greater detail below).

As similarly identified before, both pots 46′ and pumps 48′ may be in fluid communication with a vapor condenser 56′ having a fin fan system 56″ having, for example, 24 2¾ horsepower fans. Alternatively, the condenser 56′ may be cooled by cold water (30° to 80° F.) or other cooling methodology as hereinabove described. The condenser 56 may also be fluidly connected to a gas separation chamber 48, condensate pot 46′ or pump 48′ for further separation of the liquid phase from the gaseous phase.

In FIG. 3, the primary treatment process is illustrated, including multiple circulation loops. For ease of description, the three loops depicted will be generally described as circulation loops 1, 2, and 3, respectively. In circulation loop 1, generally denoted as including flash tank 30′, transfer pump 33′, and associated components, circulation loop 1 may include flash tank 30′ that receives feed water 114 that has been strained and heated by one or more pre-heaters 55A or 55B to 100°-140° F. The flash tank 30′ may function to flash off vapor from the strained and pre-heated feed water 114A, thereby concentrating the solution through vaporization of a portion of the remaining water present in the feed water 114A. The vapor produced by the flash tank 30′ typically comprises pure water, as well as some non-condensable gas/steam. The flash tank 30′ is adapted to receive brine and steam, appropriately sized based on steam expansion volume, vapor volume and pressure of the system to accommodate steam expansion and retention of a pre-programmed and/or pre-determined brine level (determined by the net positive suction head of pump and the salt conveyor height required). The flash tank 30′ also includes electronic devices or components for monitoring pressure and temperature for both the brine level and steam space to provide control points (outside the range of +/−2.5 times the water level in the vessel) for condensing steam. The flash tank 30′ may be operated at a temperature ranging from about 95° F. to about 140° F., and is preferably maintained at a vacuum pressure, 1 to 3 psi of vacuum pressure, or 12 to 14 psi of vacuum of vacuum pressure. The separate steam is released from the flash tank 30′ by changing flow through the condenser 56′ and re-circulated with steam targeted for return to one or both pre-heaters 55A and/or 55B (specifically depicted as 55A in FIG. 2).

Flash tank 30′ is in fluid communication with transfer pump 33′, which transfers material from circulation loop 1 to circulation loop 2 (which is generally denoted by flash tank 30″ and transfer pump 33″ as well as a salt settling tank 31′). The flash tank 30′ is also in fluid communication with circulation pump(s) 35′ and/or 35″, which provide adequate flow rate based upon the condensed steam from the flash tank 30′ so as to allow for heat transfer in heat exchange components (such as 37′). The circulation pump(s) 35′ or 35″ are each separately equipped with variable frequency drives to allow for flow rate management necessary for controlling variable brine density that may result through the brine fluid circulation in the system. Consistent with prior descriptions, the heat exchanger 37′ is in fluid communication with a condenser pot 39′ and a vacuum pump 41′.

Circulation loops 2 (denoted by flash tank 30″) and 3 (denoted by flash tank 30′“) are generally consistent in arrangement, and will be described accordingly except where the loops depart or differ. Loops 2 and 3 are also consistent with loop 1, having a flash tank 30” (30′″) but in fluid communication with a salt settling tank 31′ (31″), which allows crystallized salt particles to fall from the respective circulation loop (1, 2 or 3). The flash tanks 30″ and 30′″ may function to flash off vapor from the concentrate from flash tank 30′, thereby concentrating the solution through vaporization of a portion of the remaining water present in the feed water 114A. The vapor produced by the flash tanks 30″ and 30′ typically comprises pure water, as well as some non-condensable gases. The flash tank 30″ may be operated at a temperature ranging from about 155° F. to about 190° F., and is preferably maintained at a vacuum pressure, or at 4 to 7 psi of vacuum pressure, or 8 to 11 psi of vacuum pressure; the flash tank 30′′ may be operated at a temperature ranging from about 220° F. to about 240° F., and is preferably maintained at near atmospheric pressure. Each settling tank 31′ (31″) is adapted to a size (e.g., 8 to 12 feet) to allow for and/or promote a slower velocity (less than 0.2 ft. per sec.) of the brine, which allows larger salt crystals to precipitate from the brine and fall to the bottom of the settling tank and the central bottom outlet point provided in the tank 31′ (31″). It is also envisioned that first flash tank (30′) may also include in fluid communication a salt settling tank consistent with the settling tanks described herein. Once the crystals have fallen out of the brine stream, the pump 33″ (33′″) transfers the material by means of a conveyor (e.g., screw conveyor or ribbon type, configured to separate the salt from the water) to either the third flash tank 30′″ (if transferred from pump 33″) or to a salt collection shed or reservoir (if transferred from pump 33′″); the conveyor 42 for this embodiment is described hereinabove for other embodiments. The foregoing produces recovered salt 44 preferably having less than about 20 wt. % water; water from the conveyor is re-circulated through the fin fans to be condensed into recovered water.

Mist eliminators may be provided in each of the flash tanks 30′, 30″ and 30′″, to minimize brine droplet carry-over, wherein the mist eliminator is sized to slow steam velocity to less than 25 ft/sec. The flow and density instrumentation provided with the recovery unit 5 includes instruments to measure differential pressure across the eliminator to monitor potential plugging from salt crystals in vapor.

Heat exchange components (37′, 37″, or 37′″) are provided to increase the brine fluid temperature by condensing steam. In a three-circulation loop configuration, as that depicted in FIG. 3, the heat exchanger 37′ will condense steam provided from circulation loop 2, and heat exchanger 37″ will condense steam provided from circulation loop 3. Heat exchange 37′″ will increase the brine fluid temperature by 5° to 15° F. by transferring energy from the heated oil from heater 178.

A hot oil heater may be in fluid communication with one or more of the heat exchangers for increasing the brine fluid temperature. The hot oil system may comprise a network of pipelines configured to transport hot and cooled oil around to the unit operations of the recovery unit, including heat outlets provided through a plurality of heat exchangers located through the recovery unit 5. Suitable specifications for the hot oil heater are described hereinabove.

For the purposes of describing and defining the present invention it is additionally noted that the terms “substantially” and “about” are utilized herein to represent the inherent degree of uncertainty that may be attributed to any quantitative comparison, value, measurement, or other representation. The terms “substantially” and “about” are utilized herein to represent the degree by which a quantitative representation may vary from a stated reference without resulting in a change in the basic function of the subject matter at issue.

It is further noted that terms like “preferably,” “generally,” “commonly,” “desirably,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

We claim:

1. A recovery unit for treating fractionated water from a hydraulic fracturing process, the recovery unit comprising:
a feed strainer in fluid communication with at least one feed pump, the feed strainer having electronic equipment for monitoring plugging of the feed strainer;
the at least one feed pump in fluid communication with at least one flash tank, the at least one feed pump adapted to transfer raw brine fluid from external storage into the recovery unit;
at least one pre-heater in fluid communication with a condensate pot and vacuum pump, the at least one pre-heater receiving steam and the condensate pot and vacuum pump condensing the steam for transfer to at least one condensate water storage tank and removing any non-condensable gas to transfer fluid to at least one condensate storage tank; and
flow and density instrumentation to estimate reaction profiles within the recovery unit;
wherein the strainer, the at least one feed pump, the at least one flash tank, and the at least one pre-heater and condensate pot and vacuum pump comprise a material resistant to corrosion, stress, and cracking from direct contact with chloride salts.

2. The recovery unit of claim 1 further comprising means for reducing moisture content in recovered crystals from the brine fluid.

3. A recovery unit for treating fractionated water from a hydraulic fracturing process, the recovery unit comprising:
a feed strainer in fluid communication with at least one feed pump;
the at least one feed pump in fluid communication with a first flash tank;
at least one pre-heater in fluid communication with a pre-heater condensate pot and vacuum pump, the at least one pre-heater receiving steam and the pre-heater condensate pot and vacuum pump condensing the steam for transfer to at least one condensate water storage tank and removing any non-condensable gas to transfer fluid to at least one condensate storage tank;
the first flash tank separating brine fluid and steam, the first flash tank in fluid communication with a salt settling tank, the salt settling tank having a bottom outlet point for collecting crystals from the brine fluid;
the salt settling tank in fluid communication with at least one transfer pump for transferring the crystals from the brine fluid to the at least one transfer pump;
at least one circulation pump to control flow rate for heat exchange by at least one heat exchanger;
the at least one heat exchanger in fluid communication with a heat exchanger condensate pot and vacuum pump, the at least one heat exchanger receiving steam and the heat exchanger condensate pot and vacuum pump condensing steam for transfer and removing any non-condensable gas to transfer fluid to at least one condensate storage tank;
flow and density instrumentation to estimate reaction profiles within the recovery unit; and
a fluid level control in communication with a control valve, the level control providing a signal to the control valve to maintain a programmed level in the first flash tank.

4. The recovery unit of claim 3 further comprising a second flash tank and at least one salt transfer pump transferring recovered crystals from said first flash tank to said second flash tank at a flow rate.

5. The recovery unit of claim 4, wherein the at least one salt transfer pump flow rate is determined by brine density calculated by the flow and density instrumentation.

6. The recovery unit of claim 5 further comprising a crystal dryer to reduce moisture content in the recovered crystals from the brine fluid.

7. The recovery unit of claim 6, wherein the crystal dryer comprises a centrifuge.

8. The recovery unit of claim 7 further comprising a crystal washer providing water for removing additional impurities from the recovered crystals.

9. The recovery unit of claim 3 further comprising a steam condensing heat exchanger for removing latent heat from steam using low temperature fluid circulated therethrough, the steam condensing heat exchanger in fluid communication with a condensate pot and vacuum pump for condensing steam for transfer and removing any non-condensable gas to transfer fluid.

10. The recovery unit of claim 9, wherein the low temperature fluid is water cooled.

11. The recovery unit of claim 9, wherein the low temperature fluid is air cooled.

12. A recovery unit for treating fractionated water from a hydraulic fracturing process, the recovery unit comprising:
a feed strainer in fluid communication with at least one feed pump;
the at least one feed pump in fluid communication with at least one flash tank;
at least one pre-heater in fluid communication with a pre-heater condensate pot and vacuum pump, the at least one pre-heater receiving steam and the pre-heater condensate pot and vacuum pump condensing the steam for transfer to at least one condensate water storage tank and removing any non-condensable gas to transfer fluid to at least one condensate storage tank;
a first flash tank, a second flash tank, and third flash tank, the first flash tank in fluid communication with the second flash tank, the second flash tank in fluid communication with the third flash tank, each one of the flash tanks separating brine fluid and steam, and each one of the second and third flash tanks in fluid communication with an associated salt settling tank, each one of the salt settling tanks having a bottom outlet point for collecting crystals from the brine fluid;
each one of the salt settling tanks in fluid communication with at least one transfer pump for transferring the crystals from the brine fluid to the at least one transfer pump;
at least one circulation pump to control flow rate for heat exchange by at least one heat exchanger for each one of the flash tanks and salt settling tanks;
the at least one heat exchanger in fluid communication with a heat exchanger condensate pot and vacuum pump, the at least one heat exchanger receiving steam and the heat exchanger condensate pot and vacuum pump condensing steam for transfer and removing any non-condensable gas to transfer fluid to at least one condensate storage tank;
a hot oil heater in fluid communication with the at least one heat exchanger for increasing the brine fluid temperature;
flow and density instrumentation to estimate reaction profiles within the recovery unit; and
a fluid level control in communication with a control valve, the level control providing a signal to the control valve to maintain a programmed level in each of the first, second and third flash tanks.

13. The recovery unit of claim 12 further comprising a first salt transfer pump between the first flash tank and the second flash tank, and a second salt transfer pump between the second flash tank and the third flash tank, the first salt transfer pump transferring recovered crystals from the first flash tank to the second flash tank and the second salt transfer pump transferring recovered crystals from the second flash tank to the third flash tank.

14. The recovery unit of claim 13, wherein the flow rate of the first salt transfer pump and the second salt transfer pump is determined by brine density calculated by the flow and density instrumentation.

15. The recovery unit of claim 13 further comprising a crystal dryer to reduce moisture content in the recovered crystals from the brine fluid.

16. The recovery unit of claim 15, wherein the crystal dryer comprises a centrifuge.

17. The recovery unit of claim 16 further comprising a crystal washer providing water for removing additional impurities from the recovered crystals from the brine fluid.

18. The recovery unit of claim 12 further comprising a steam condensing heat exchanger for removing latent heat from steam using low temperature fluid circulated therethrough, the steam condensing heat exchanger in fluid communication with a condensate pot and vacuum pump for condensing steam for transfer and removing any non-condensable gas to transfer fluid.

19. The recovery unit of claim 18, wherein the low temperature fluid is water cooled.

20. The recovery unit of claim 18, wherein the low temperature fluid is air cooled.
